(19) United States
(12) Patent Application Publication
(10) Pub. No.: US 2006/0089856 A1
(43) Pub. Date: Apr. 27, 2006

(54) Integrated pharmaceutical dispensing and patient management monitoring

(75) Inventors: Veerichetty Kadhiresan, Centerville, MN (US); David H. Johnson, Inver Grove Heights, MN (US); Don Goscha, Elk River, MN (US); Marina Brockway, Shoreview, MN (US); Muralidharan Srivathsa, Shoreview, MN (US)

Correspondence Address: MERCHANT & GOULD PC, P.O. BOX 2903, MINNEAPOLIS, MN, 55402-0903, US

(73) Assignee: Cardiac Pacemakers

(21) Appl. No.: 10/970,286

(22) Filed: Oct. 21, 2004

(51) Int. Cl. G06Q 10/00

(52) U.S. Cl. 705/2

(57) ABSTRACT

A pharmaceutical monitoring system includes a communication system, a host, and an interrogator/transmitter unit. The communication system is configured to upload patient drug parameters from a pharmaceutical information source to the host, and the interrogator/transmitter unit is configured to download the patient drug parameters from the host via the communication system and provide patient prompts based on the downloaded patient drug parameters. The interrogator/transmitter unit may also be configured to receive patient inputs in response to the patient prompts and upload information to the host via the communication system that is based on the patient inputs, patient prompts, and patient drug parameters.

### TECHNICAL FIELD

The present invention generally relates to monitoring patients from a remote location, and more specifically relates to systems and methods for monitoring patient compliance with drug regimes and drug efficacy in the patient from a remote location.

### BACKGROUND

Management of patients with chronic disease consumes a significant proportion of the total health care expenditure in the United States. Many of these diseases are widely prevalent and have significant annual incidences as well. Heart failure prevalence alone is estimated at over 5.5 million patients in 2000 with incidence rates of over half a million additional patients annually, resulting in a total health care burden in excess of $20 billion. Heart failure, like many other chronic diseases such as asthma, COPD, chronic pain, and epilepsy, is event driven, where acute de-compensations result in hospitalization. In addition to causing considerable physical and emotional trauma to the patient and family, event driven hospitalizations consume a majority of the total health care expenditure allocated to the treatment of heart failure. Hospitalization and treatment for an acute de-compensation typically occurs after the de-compensation event has happened. However, most heart failure patients exhibit prior non-traumatic symptoms, such as steady weight gain, in the weeks or days prior to the de-compensation. If the caregiver is aware of these symptoms, it is possible to intervene before the event, at substantially less cost to the patient and the health care system. Intervention is usually in the form of a re-titration of the patient's drug cocktail, reinforcement of the patient's compliance with the prescribed drug regimen, or acute changes to the patient's diet and exercise. Such intervention is usually effective in preventing the de-compensation episode and thus avoiding hospitalization. Patients with chronic heart disease can receive implantable cardiac devices such as pacemakers, implantable cardioverter defibrillators (ICDs), and heart failure cardiac resynchronization therapy (CRT) devices. Currently, the electrophysiologist that implants pacemakers and ICDs requires their patients to make clinic visits periodically, usually once every three or four months, in order to verify if their implanted device is working correctly and programmed optimally. Device follow-ups are usually performed by the nurse-staff assisted by the sales representative from the device manufacturers. Device follow-ups are labor intensive and typically require patients to make multiple clinic visits.

The data the caregiver does receive regarding a patient requires the caregiver to analyze the data and provide predictive and post-event diagnosis based on the data. However, as the amount of data collected regarding a particular patient increases, it becomes more difficult for a caregiver to assimilate and provide a meaningful analysis of all of the data all of the data. In addition, it is difficult for a caregiver to identify trends and other information from particular patients and leverage this knowledge for the treatment of larger populations.

It would therefore be desirable to develop an automated system to collect data regarding the physiological condition of a patient, as well as collect data from implanted devices, and to automate the process of analyzing the data.

### SUMMARY OF THE INVENTION

The present invention generally relates to monitoring patients from a remote location, and more specifically relates to systems and methods for monitoring patient compliance with drug regimes and drug efficacy in the patient from a remote location.

One aspect of the invention relates to a pharmaceutical monitoring system that includes a communication system, a host, and an interrogator/transmitter unit. The communication system is configured to upload patient drug parameters from a pharmaceutical information source to the host, and the interrogator/transmitter unit is configured to download the patient drug parameters from the host via the communication system, provide patient prompts based on the downloaded patient drug parameters, receive patient inputs in response to the patient prompts, and upload information to the host via the communication system that is based on the patient inputs, patient prompts, and patient drug parameters.

Another aspect of the invention relates to a method of monitoring compliance of a drug regimen using a communication system, a host, and an interrogator/transmitter unit. The method includes uploading a set of patient drug parameters to the host via the network, downloading the patient drug parameters from the host onto the interrogator/transmitter unit via the communication system, entering patient inputs into the interrogator/transmitter unit, and generating a compliance report based on the drug parameters and patient inputs.

A still further aspect of the invention relates to a method of monitoring a drug related patient condition from a remote location using a communication system and an interrogator/transmitter unit. The method includes downloading drug parameters from the communication system to the interrogator/transmitter unit, entering drug related patient inputs into the interrogator/transmitter unit, uploading the patient inputs from the interrogator/transmitter unit onto the communication system and accessing the patient inputs from a remote location via the communication system to determine a patient condition.

### BRIEF DESCRIPTION OF THE DRAWINGS

The invention may be more completely understood in consideration of the following detailed description of various embodiments of the invention in connection with the accompanying drawings, in which:

FIG. 1 illustrates an example advanced patient management system made in accordance with the present invention;

FIG. 2 illustrates an example interrogator/transceiver unit made in accordance with the present invention;

FIG. 3 illustrates an example communication system made in accordance with the present invention;

FIG. 4 illustrates another example advanced patient management system made in accordance with the present invention;

FIG. 5 illustrates a schematic process diagram of example input to and outputs from an advanced patient management system in accordance with the present invention; and

FIG. 6 illustrates an example method for monitoring patient compliance with and efficacy of a patient drug regimen.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION OF THE PREFERRED EMBODIMENT

The present system and methods are described generally with respect to an advanced patient management (“APM”) system configured to collect patient-specific information, store and collate the information, and generate actionable recommendations to enable the predictive management of patients. The APM system is also configured to leverage a remote communications infrastructure to provide automatic device follow-ups to collect data, coordinate therapy, and to determine if remote devices are functioning properly.

More specifically, the APM system is configured to monitor patient compliance with a drug regimen, determine and monitor efficacy of the drug regimen, and monitor any side effects resulting from the drug regimen. The APM system may be configured to use pharmaceutical parameters and patient health history provided by at least one of a primary care giver (e.g., a doctor), a pharmaceutical network and a pharmaceutical information database in conjunction with patient physical indicators to help determine accuracy of the drug regimen compliance, drug efficacy, and side effects. The example APM systems disclosed herein may also be configured to produce reports related to compliance, efficacy, and side effects of the drug regimen and communicate those reports to various destinations, such as, for example, a primary caregiver, the patient, a pharmacokinetics database, or a pharmaceutical network.

The term “patient” is used herein to mean any individual from whom information is collected. The term “caregiver” is used herein to mean any provider of services, such as health care providers including, but not limited to, nurses, doctors, and other health care provider staff. The term “pharmacokinetics” is used herein to mean the sway that drugs move through the body after they are administered to a patient and the expected physiological response to the drug.

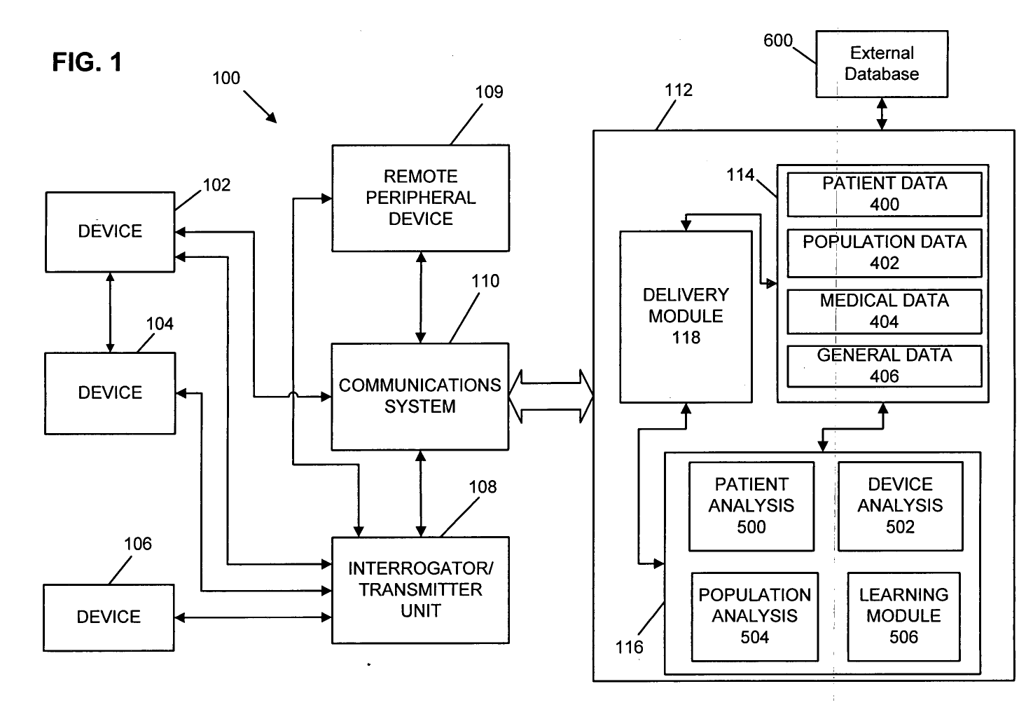

FIG. 1 illustrates an example APM system 100 made in accordance with the present invention. APM system 100 generally includes the following components: one or more devices 102, 104, and 106, one or more interrogator/transceiver units 108, a communication system 110, one or more remote peripheral devices 109, and a host 112.

Each component of the APM system 100 can communicate using the communication system 110. Some components may also communicate directly with one another. For example, devices 102 and 104 may be configured to communicate directly with one another. The various components of the example APM system 100 illustrated herein are described below.

I. Devices

Devices 102, 104, and 106 can be implantable devices or external devices that may provide at least one of the following functions with respect to a patient in addition to other possible functions: (1) sensing/measuring, (2) data analysis, (3) therapy, (4) distribution of product, and (5) communication. For example, in one embodiment, devices 102, 104, and 106 are either implanted or external devices used to sense or measure a variety of physiological, subjective, and environmental conditions of a patient using electrical, mechanical, and/or chemical means. The devices 102, 104, and 106 can be configured to automatically gather data or can require manual intervention by the patient. The devices 102, 104, and 106 can be devices that are positioned external and separated from the patient, positioned on an external surface of the patient, or positioned within the patient as an implanted device or sensor. The devices 102, 104, and 106 can be configured to store data related to the physiological and/or subjective measurements and/or transmit the data to the communication system 110 using a variety of methods, described in detail below. Although three devices 102, 104, and 106 are illustrated in the example embodiment shown, more or fewer devices may be used for a given patient.

The devices 102, 104, and 106 can be configured to analyze the measured data and act upon the analyzed data. For example, the devices 102, 104, and 106 are configured to modify therapy or provide alarm indications based on the analysis of the data.

In one embodiment, devices 102, 104, and 106 also provide therapy. Therapy can be provided automatically or in response to an external communication. Devices 102, 104, and 106 are programmable in that the characteristics of their sensing, therapy (e.g., duration and interval), or communication can be altered by communication between the devices 102, 104, and 106 and other components of the APM system 100. Devices 102, 104, and 106 can also perform self-checks or be interrogated by the communication system 110 to verify that the devices are functioning properly.

In another embodiment, devices 102, 104, and 106 also provide dispersement of product. Product dispersement can be provided automatically or in response to an external communication. Some example products that may be dispersed include pills/drugs that are part of a patient drug regimen and testing/sampling products for patient conducted tests or sampling bodily products.

The devices 102, 104, and 106 can be configured to communicate with the patient and with other devices and features of the APM. For example, the devices 102, 104, and 106 can communicate with a patient using sound or visual prompts to, for example, obtain answers to questions, remind the patient to perform certain tasks, and warn the patient about the presence of predetermined threshold trends and conditions that represent the patient's wellbeing. The devices 102, 104, and 106 may also include user interface features such as a keypad, touch control screen, or other input device that facilitate communication between the patient and the devices 102, 104, and 106. Additional examples of different embodiments of the devices 102, 104, and 106 are provided below.

Devices implanted within the body have the ability to sense and communicate as well as to provide therapy. Implantable devices can provide direct measurement of characteristics of the body, including, without limitation, electrical cardiac activity (e.g., a pacemaker, cardiac resynchronization management device, defibrillator, etc.), physical motion, temperature, heart rate, activity, blood pressure, breathing patterns, ejection fractions, blood viscosity, blood chemistry, blood glucose levels, and other patient-specific clinical physiological parameters, while minimizing the need for patient compliance.

A heart rhythm sensor, typically found in a pacemaker or defibrillator, is one example of an implantable device. In the heart, an electrical wave activates the heart muscle just prior to contraction. As is known in the art, electrical circuits and lead-wires transduce the heart's activation event and reject other, non-essential electrical events. By measuring the time interval between activation events, the heart rhythm can be determined. A transthoracic impedance sensor is another example of a sensor in an implantable device. During the respiratory cycle, large volumes of air pass into and out of the body. The electrical resistance of the thorax changes markedly as a result of large differences in conductivity of air and body tissues. The thoracic resistance can be measured during respiration and converted into a measurable electrical signal (i.e., impedance) so that breathing rate and profile can be approximated. Implantable devices can also sense chemical conditions, such as glucose levels, blood oxygen levels, etc. Further, the APM system 100 may utilize other implantable devices as well that provide physiological measurements of the patient, such as drug pumps, neurological devices (e.g., stimulators), oxygen sensors, etc.

Derived measurements can also be determined from the implantable device sensors. For example, a sleep sensor can rely on measurements taken by an implanted accelerometer that measures body activity levels. The sleep sensor can estimate sleeping patterns based on the measured activity levels. Other derived measurements include, but are not limited to, a functional capacity indicator, autonomic tone indicator, sleep quality indicator, cough indicator, anxiety indicator, and cardiovascular wellness indicator for calculating a quality of life indicator quantifying a patient's overall health and well-being.

Devices 102, 104, and 106 can also be external devices, or devices that are not implanted in the human body, that are used to measure physiological data. Such devices include a multitude of devices to measure data relating to the human body, such as temperature (e.g., a thermometer), blood pressure (e.g., a sphygmomanometer), blood characteristics (e.g., glucose levels), body weight, physical strength, mental acuity, diet, heart characteristics, and relative geographic position (e.g., a Global Positioning System (GPS)).

Devices 102, 104, and 106 can also be environmental sensors. The devices can be placed in a variety of geographic locations (in close proximity to patient or distributed throughout a population) and record non-patient specific characteristics such as, but not limited to, temperature, air quality, humidity, carbon monoxide level, oxygen level, barometric pressure, light intensity, and sound.

One or more of the devices 102, 104, and 106 (for example, device 106) may be external devices that measure subjective or perceptive data from the patient. Subjective data is information related to a patient's feelings, perceptions, and/or opinions, as opposed to objective physiological data. For example, the “subjective” devices can measure patient responses to inquiries such as “How do you feel?” and “How is your pain?” The device can prompt the patient and record subjective data from the patient using visual and/or audible cues. For example, the patient can press coded response buttons or type an appropriate response on a keypad. Alternatively, subjective data may be collected by allowing the patient to speak into a microphone and using speech recognition software to process the subjective data.

In one example embodiment, the subjective device presents the patient with a relatively small number of responses to each question posed to the patient. For example, the responses available to the patient may include three faces representing feelings of happiness, nominalness, and sadness. Averaged over time, a trend of a patient's well being will emerge from the patient's choices.

The subjective data can be collected from the patient at set times, or, alternatively, collected whenever the patient feels like providing subjective data. The subjective data can also be collected substantially contemporaneously with physiological data to provide greater insight into overall patient wellness. The subjective device 106 can be any device that accepts input from a patient or other concerned individual and/or provides information in a format that is recognizable to the patient. Device 106 typically includes a keypad, mouse, display, handheld device, interactive TV, cellular telephone or other radio frequency (“RF”) communications device, cordless phone, corded phone, speaker, microphone, email message, or physical stimulus.

The APM system 100 may also include one or more remote peripheral devices 109. The remote peripheral device 109 may include, for example and without limitation, cellular telephones, pagers, PDA devices, facsimiles, remote computers, printers, video and/or audio devices, etc. The remote peripheral device 109 can communicate using wired or wireless technologies and may be used by the patient or caregiver to communicate with the communication system 110 and/or the host 112. For example, the remote peripheral device 109 can be used by the caregiver to receive alerts from the host 112 based on data collected from the patient and to send instructions from the caregiver to either the patient or other clinical staff. In another example, the remote peripheral device 109 is used by the patient to receive periodic or real time updates and alerts regarding the patient's health and well-being.

II. Interrogator/Transceiver Unit

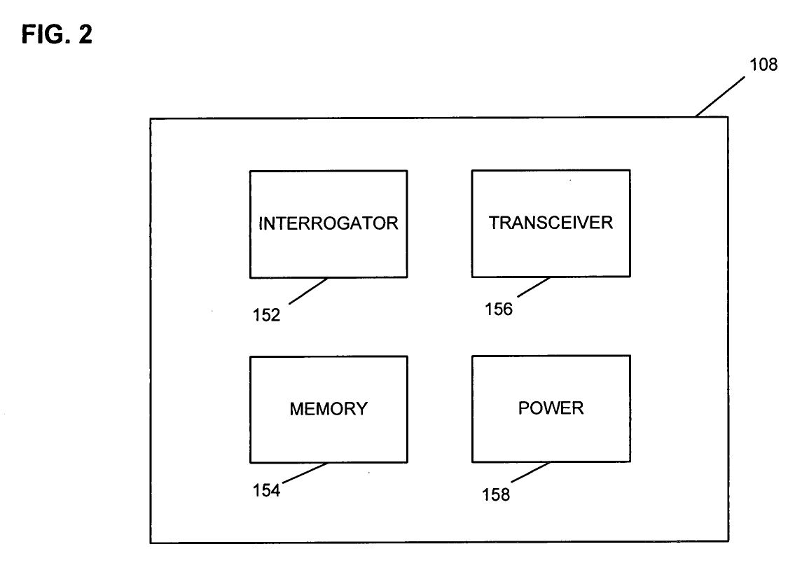

Referring now to FIG. 2, the example APM system 100 includes one or more interrogator/transceiver units (“ITUs”), such as ITU 108. The ITU 108 includes an interrogator module 152 for sending and receiving data from a device, such as devices 102, 104, and 106, a memory module 154 for storing data, and a transceiver module 156 for sending and receiving data to and from other components of the APM system 100. The transceiver module may also operate as an interrogator of the devices 102, 104 and 106. The ITU 108 also includes a power module 158 that provides power.

The ITU 108 may perform one or more of the following functions: (1) data storage; (2) data analysis; (3) data forwarding; (4) patient interaction; (5) patient feedback; and (6) data communications. For example, the ITU 108 may facilitate communications between the devices 102, 104, and 106 and the communication system 110. The ITU 108 can, periodically or in real-time, interrogate and download into memory clinically relevant patient data from the devices 102, 104, and/or 106. This data includes, in the cardiac sensor context, for example, P and R-wave measurements, pacing, shocking events, lead impedances, pacing thresholds, battery voltage, capacitor charge times, ATR episodes with electrograms, tachycardia episodes with electrograms, histogram information, physiological conditions that represent efficacy and compliance of a drug regimen, and any other clinical information necessary to ensure patient health and proper device function. The data is sent to the ITU 108 by the devices 102, 104, and 106 in real-time or periodically uploaded from buffers in the devices.

The ITU 108 may also allow patient interaction. For example, the ITU 108 may include a patient interface and allow the patient to input subjective data. In addition, the ITU 108 may provide feedback to the patient based on the data that has been analyzed or based on information communicated by the communication system 110.

In another embodiment, the ITU 108 includes a telemetry link from the devices to a network that forms the basis of a wireless LAN in the patient's home. The ITU 108 systematically uploads information from the devices 102, 104, and/or 106 while the patient is sleeping, for example. The uploaded data is transmitted through the communication system 110 or directly to the host 112. In addition, in one embodiment the ITU 108 functions in a hybrid form, utilizing wireless communication when available and defaulting to a local wireless portal or a wired connection when the wireless communication becomes unavailable.

Some devices, such as legacy implanted cardiac rhythm management (“CRM”) devices, communicate via an internal telemetry transceiver that communicates with an external programmer. The communication range of such devices is typically 1 to 4 inches. ITU 108 may include a special short-range interrogator that communicates with a legacy device.

When the interrogator 152 uses radio frequency to communicate with the devices 102, 104, 106, the ITU 108 may be in the form of a small device that is placed in an inconspicuous place within the patient's residence. Alternatively, the ITU 108 may be implemented as part of a commonly used appliance in the patient's residence. For example, the ITU may be integrated with an alarm clock that is positioned near the patient's bed. In another embodiment, the ITU may be implemented as part of the patient's personal computer system. Other embodiments are also possible.

In another embodiment, the ITU 108 may comprise a hand-held device such as a PDA, cellular telephone, or other similar device that is in wireless communication with the devices 102, 104, and 106. The hand-held device may upload the data to the communication system 110 wirelessly. Alternatively, the hand-held device may periodically be placed in a cradle or other similar device that is configured to transmit the data to the communication system 110.

In one embodiment, the ITU 108 can perform analysis on the data and provide immediate feedback, as well as perform a variety of self-diagnostic tests to verify that it is functioning properly and that communication with the communication system 110 has not be compromised. For example, the ITU 108 can perform a diagnostic loop-back test at a time set by the host 112, which involves sending a request through the communication system 110 to the host 112. The host 112 can then reply with a response back through the communication system 110 to the ITU 108. If a specific duration elapses before the ITU 108 receives the response or the ITU 108 receives an unexpected response, or if the host 112 does not receive the diagnostic test communication, the ITU 108 can provide indications that the system is not functioning properly and the host 112 can alert an operator that there may be compromised communications with that specific ITU 108. For example, if wireless communications between the ITU 108 and the communication system 110 have been interrupted, and the ITU 108 performs a self-diagnostic test that fails, the ITU 108 may alert the patient so that corrective action may be taken. The alert can take the form of a sound or a visual and/or audible annunciator to alert the patient that communication has been interrupted. In another embodiment, the ITU 108 can automatically fail-back to a wired system to communicate with the communication system 110 and perform the same communications compromise checks.

In other embodiments of the APM system 100, the ITU 108 function can be integrated into devices 102, 104, and 106, so that the devices can communicate directly with the communication system 110 and/or host 112. The devices 102, 104 and 106 can incorporate multi-mode wireless telecommunications such as cellular, BLUETOOTH, or IEEE 802.11B to communicate with the communication system 110 directly or through a local wireless to a wired portal in the patients' home. For example, device 102 may include a miniature cellular phone capable of wirelessly uploading clinical data from the device on a periodic basis. This is particularly advantageous for devices that are mobile (e.g., an implanted device in a patient that is traveling).

To conserve the energy of the devices 102, 104, and 106, particularly when the devices (e.g., device 102) are configured to communicate directly with the communication system 110 without using an ITU 108, in one example embodiment the devices are configured to communicate during a given duty cycle. For example, the device 102 can be configured to communicate with the communication system 110 at given intervals, such as once a week. The device 102 can record data for the time period (e.g., a week) and transmit the data to the communication system 110 during the portion of the cycle that transmission is active and then conserve energy for the rest of the cycle. In another example, the device 102 conserves energy and only communicates with the communication system 110 when an “interesting” event, such as a heart arrhythmia, has occurred. In this manner, device 102 can communicate directly with the communication system 110 and/or host 112 without requiring an ITU 108, while conserving the energy of the device by communicating only during a given duty cycle.

The interrogation rate of the ITU 108 can be varied depending on disease state and other relevant factors. In addition, the devices 102, 104, and 106 can be configured to “wake up” frequently (e.g., once every couple minutes) to provide the ITU 108 an access window for the ITU 108 to provide commands to the devices 102, 104, and 106, as well as upload data from the devices.

If multiple devices, such as devices 102, 104, and 106, are provided for a given patient, each device may include its own means for communicating with the ITU 108 or communication system 110. Alternatively, a single telemetry system may be implemented as part of one of the devices, or separate from the devices, and each device 102, 104, and 106 can use this single telemetry system to communication with the ITU 108 or the communication system 110.

In yet another embodiment, the devices 102, 104, and 106 include wires or leads extending from devices 102, 104, and 106 to an area external of the patient to provide a direct physical connection. The external leads can be connected, for example, to the ITU 108 or a similar device to provide communications between the devices 102, 104, and 106 and the other components of the APM system 100.

The APM system 100 can also involve a hybrid use of the ITU 108. For example, the devices 102, 104, and 106 can intelligently communicate via short-range telemetry with the ITU when the patient is located within the patient's home and communicate directly with the communication system 110 or host 112 when the patient is traveling. This may be advantageous, for example, to conserve battery power when the devices are located near an ITU.

III. Communication System

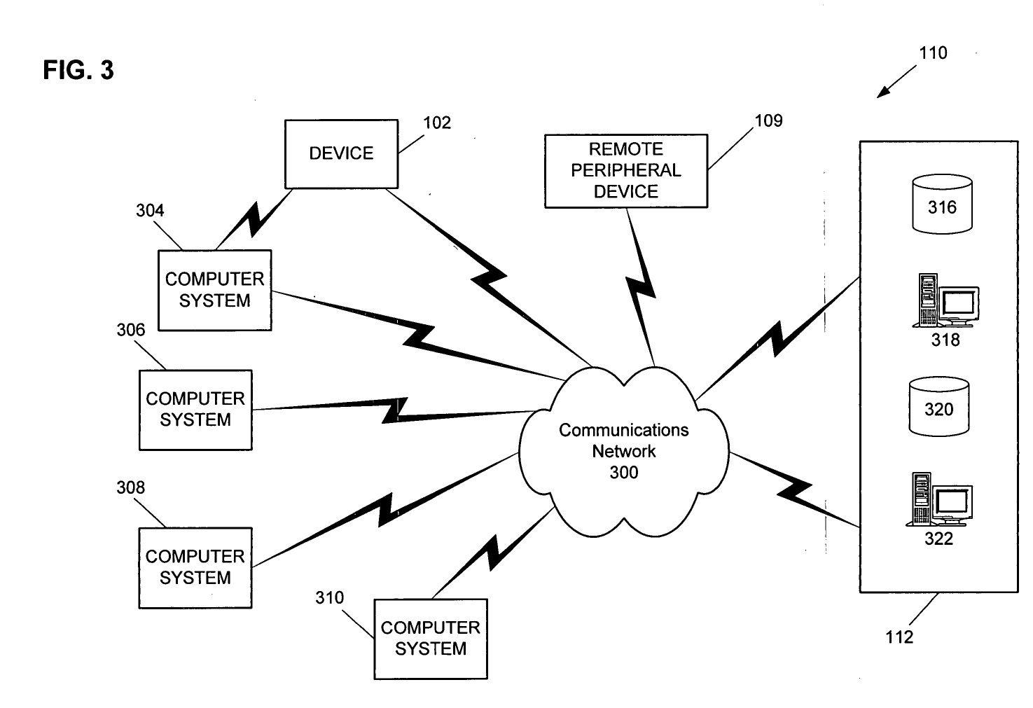

Communication system 110 provides for communications between and among the various components of the APM system 100, such as the devices 102, 104, and 106, host 112, and remote peripheral device 109. FIG. 3 illustrates one embodiment for the communication system 110 made in accordance with the present invention. The communication system 110 includes a plurality of computer systems 304, 306, 308, and 310, as well as device 102, host 112, and remote peripheral device 109, connected to one another by the communication system 300. The communication system 300 may be, for example, a local area network (LAN), wide area network (WAN), or the Internet. Communications among the various components, as described more fully below, may be implemented using wired or wireless technologies.

In the example embodiment illustrated, the host 112 includes server computers 318 and 322 that communicate with computers 304, 306, 308, and 310 using a variety of communications protocols that are described more fully below. The server computers 318 and 322 store information in databases 316 and 320. This information may also be stored in a distributed manner across one or more additional servers.

A variety of communication methods and protocols may be used to facilitate communication between devices 102, 104, and 106, ITU 108, communication system 110, host 112, and remote peripheral device 109. For example, wired and wireless communications methods may be used. Wired communication methods may include, for example and without limitation, traditional copper-line communications such as DSL, broadband technologies such as ISDN and cable modems, and fiber optics, while wireless communications may include cellular, satellite, radio frequency (RF), Infrared, etc.

For any given communication method, a multitude of standard and/or proprietary communication protocols may be used. For example and without limitation, protocols such as radio frequency pulse coding, spread spectrum, direct sequence, time-hopping, frequency hopping, SMTP, FTP, and TCP/IP may be used. Other proprietary methods and protocols may also be used. Further, a combination of two or more of the communication methods and protocols may also be used.

The various communications between the components of the APM system 100 may be made secure using several different techniques. For example, encryption and/or tunneling techniques may be used to protect data transmissions. Alternatively, a priority data exchange format and interface that are kept confidential may also be used. Authentication can be implemented using, for example, digital signatures based on a known key structure (e.g., PGP or RSA). Other physical security and authentication measures may also be used, such as security cards and biometric security apparatuses (e.g., retina scans, iris scans, fingerprint scans, veinprint scans, voice, facial geometry recognition, etc.). Conventional security methods such as firewalls may be used to protect information residing on one or more of the storage media of the APM system 100. Encryption, authentication and verification techniques may also be used to detect and correct data transmission errors.

Communications among the various components of the APM system 100 may be enhanced using compression techniques to allow large amounts of data to be transmitted efficiently. For example, the devices 102, 104, and 106 or the ITU 108 may compress the recorded information prior to transmitting the information to the ITU 108 or directly to the communication system 110.

The communication methods and protocols described above can facilitate periodic and/or real-time delivery of data.

IV. Host

The example host 112 includes a database module 114, an analysis module 116, and a delivery module 118 (see FIG. 1). Host 112 preferably includes enough processing power to analyze and process large amounts of data collected from each patient, as well as to process statistics and perform analysis for large populations. For example, the host 112 may include a mainframe computer or multi-processor workstation. The host 112 may also include one or more personal computer systems containing sufficient computing power and memory. The host 112 may include storage medium (e.g., hard disks, optical data storage devices, etc.) sufficient to store the massive amount of high-resolution data that is collected from the patients and analyzed.

The host 112 may also include identification and contact information (e.g., IP addresses, telephone numbers, or a product serial number) for the various devices communicating with it, such as ITU 108 and peripheral device 109. For example, each ITU 108 is assigned a hard-coded or static identifier (e.g., IP address, telephone number, etc.), which allows the host 112 to identify which patient's information the host 112 is receiving at a given instant. Alternatively, each device 102, 104, and 106 may be assigned a unique identification number, or a unique patient identification number may be transmitted with each transmission of patient data.

When a device is first activated, several methods may be used to associate data received by the APM system 100 with a given patient. For example, each device may include a unique identification number and a registration form that is filled out by the patient, caregiver, or field representative. The registration form can be used to collect the necessary information to associate collected data with the patient. Alternatively, the user can logon to a web site to allow for the registration information to be collected. In another embodiment, a barcode is included on each device that is scanned prior to or in conjunction deployment of the device to provide the information necessary to associate the recorded data with the given patient.

Referring again to FIG. 1, the example database module 114 includes a patient database 400, a population database 402, a medical database 404, and a general database 406, all of which are described further below.

The patient database 400 includes patient specific data, including data acquired by the devices 102, 104, and 106. The patient database 400 also includes a patient's medical records, the patient's current health information, targeted health information, and pharmaceutical information. The patient database 400 can include historical information regarding the devices 102, 104, and 106. For example, if device 102 is an implantable cardioverter defibrillator (ICD), the patient database 400 records the following device information: P and R measurements, pacing frequency, pacing thresholds, shocking events, recharge time, lead impedance, battery voltage/remaining life, ATR episode and EGMs, histogram information, and other device-specific information. The information stored in the database 400 can be recorded at various times depending on the patient requirements or device requirements. For example, the database 400 is updated at periodic intervals that coincide with the patient downloading data from the device. Alternatively, data in the database 400 can be updated in real time. Typically, the sampling frequency depends on the health condition being monitored and the co-morbidities.

The population database 402 includes non-patient specific data, such as data relating to other patients and population trends. The population database 402 also records epidemic-class device statistics and patient statistics. The population database 402 also includes data relating to staffing by health care providers, environmental data, pharmaceuticals, etc. In some cases, patient information from the patient database 400 may be added to the population database to supplement and maintain currency of the population database information and trends.

The example medical database 404 includes clinical data relating to the treatment of diseases. For example, the medical database 404 includes historical trend data for multiple patients in the form of a record of progression of their disease(s) along with markers of key events.

The general database 406 includes non-medical data of interest to the patient. The general database 406 can include information relating to, for example, news, finances, shopping, technology, entertainment, and/or sports. The general database 406 can be customized to provide general information of specific interest to the patient. For example, stock information can be presented along with the latest health information as detected from the devices 102, 104, and 106.

In another embodiment, information is also provided from an external source, such as external database 600. For example, the external database 600 may include external medical records and drug prescription records maintained by a pharmacy for a patient, as well as pharmacokinematics, pharmacodynamics, drug side effects, drug compatibility, and other drug related information for the type of drugs that have been prescribed for a patient. External database 600 may also include pharmacogenomic information and clinical guidelines that are stored at a remote location.

The example analysis module 116 includes a patient analysis module 500, device analysis module 502, population analysis module 504, and learning module 506. Patient analysis module 500 may utilize information collected by the APM system 100, as well as information for other relevant sources, to analyze data related to a patient and provide timely and predictive assessments of the patient's well being. In performing this analysis, the patient device module 500 may utilize data collected from a variety of sources, include patient specific physiological and subjective data collected by the APM system 100, medical and historical records (e.g., lab test results, histories of illnesses, etc., drugs currently and previously administered, etc.), as well as information related to population trends provided from sources external to the APM system 100.

For example, in one embodiment, the patient analysis module 500 makes a predictive diagnosis of an oncoming event based on information stored in the database module 114. For example, the data continuously gathered from a device of a given patient at a heightened risk for a chronic disease event (such as de-compensations in heart failure) is analyzed. Based on this analysis, therapy, typically device-based or pharmaceutical, is then be applied to the patient either through the device or through clinician intervention.

In another example embodiment, the patient analysis module 500 provides a diagnosis of patient health status and predicted trend based on present and recent historical data collected from a device as interpreted by a system of expert knowledge derived from working practices within clinics. For example, the patient analysis module 500 performs probabilistic calculations using currently collected information combined with regularly collected historical information to predict patient health degradation.

In another example embodiment, the patient analysis module 500 may conduct pre-evaluation of the incoming data stream combined with patient historical information and information from patients with similar disease states. The pre-evaluation system is based on data derived from working clinical practices and the records of outcomes. The derived data is processed in a neural network, fuzzy logic system, or equivalent system to reflect the clinical practice. Further, the patient analysis module 500 may also provide means for periodic processing of present and historical data to yield a multidimensional health state indication along with disease trend prediction, next phase of disease progression co-morbidities, and inferences about what other possible diseases may be involved. The patient analysis module 500 may also integrate data collected from internal and external devices with subjective data to optimize management of overall patient health.

Device analysis module 502 analyzes data from the devices 102, 104, and 106 and ITU 108 to predict and determine device issues or failures. For example, if an implanted device 102 fails to communicate at an expected time, device analysis module 502 determines the source of the failure and takes action to restore the performance of the device 102. The device analysis module 502 may also perform additional deterministic and probabilistic calculations. For example, the device analysis module 502 gathers data related to charge levels within a given device, such as an ICD, and provides analysis and alerting functions based on this information if, for example, the charge level reaches a point at which replacement of the device and/or battery is necessary. Similarly, early degradation or imminent failure of implanted devices can be identified and proactively addressed, or at-risk devices can be closely monitored.

Population analysis module 504 uses the data collected in the database module 114 to manage the health of a population. For example, a clinic managing cardiac patients can access the APM system 100 and thereby obtain device-supplied advance information to predict and optimize resource allocation both as to immediate care and as a predictive metric for future need of practicing specialists. As another example, the spread of disease in remote populations can be localized and quarantined rapidly before further spread.

In one embodiment, population analysis module 504 trends the patient population therapy and management as recorded by the devices and directs health care resources to best satisfy the needs of the population. The resources can include people, facilities, supplies, and/or pharmaceuticals. In other embodiments, the population analysis module detects epidemics and other events that affect large population groups. The population analysis module 504 can issue alerts that can initiate a population quarantine, redirect resources to balance size of staffing with number of presenting population, and predict future need of qualified specialists.

The population analysis module 504 may utilize a variety of characteristics to identify like-situated patients, such as, for example, sex, age, genetic makeup, etc. The population analysis module 504 may develop large amounts of data related to a given population based on the information collected by the APM system 100. In addition, the population analysis module 504 may integrate information from a variety of other sources. For example, the population analysis module 504 may utilize data from public domain databases (e.g., the National Institute of Health), public and governmental and health agency databases, private insurance companies, medical societies (e.g., the American Heart Association), and genomic records (e.g., DNA sequences).

In one embodiment of the invention, the host 112 may be used as a “data clearinghouse,” to gather and integrate data collected from the devices 102, 104, and 106, as well as data from sources outside the APM system 100, such as the external database 600. The integrated data can be shared with other interested entities, subject to privacy restrictions, thereby increasing the quality and integration of data available.

Learning module 506 analyzes the data provided from the various information sources, including the data collected by the advanced patient system 100 and external information sources. For example, the learning module 506 analyzes historical symptoms, diagnoses, and outcomes along with time development of the diseases and co-morbidities. The learning module 506 can be implemented via a neural network (or equivalent) system.

The learning module 506 can be partially trained (i.e., the learning module 506 may be implemented with a given set of preset values and then learn as the APM system functions) or untrained (i.e., the learning module 506 is initiated with no preset values and must learn from scratch as the APM system functions). In other alternative embodiments, the learning module 506 may continue to learn and adjust as the APM system functions (i.e., in real time), or the learning module 506 may remain at a given level of learning and only advanced to a higher level of understanding when manually allowed to do so.

In a neural network embodiment, new clinical information is presented to create new neural network coefficients that are distributed as a neural network knowledge upgrade. The learning module 506 can include a module for verifying the neural network conclusions for clinical accuracy and significance. The learning module can analyze a database of test cases, appropriate outcomes and relative occurrence of misidentification of the proper outcomes. In some embodiments, the learning module 506 can update the analysis module 116 when the analysis algorithms exceed a threshold level of acceptable misidentifications.

The example learning module 506 uses various algorithms and mathematical modeling such as, for example, trend and statistical analysis, data mining, pattern recognition, cluster analysis, neural networks and fuzzy logic. Learning module 506 may perform deterministic and probabilistic calculations. Deterministic calculations include algorithms for which a clear correlation is known between the data analyzed and a given outcome. For example, there may be a clear correlation between the energy left in a battery of an implantable device and the amount of time left before the battery must be replaced.

A probabilistic calculation involves the correlation between data and a given outcome that is less than 100 percent certain. Probabilistic determinations require an analysis of several possible outcomes and an assignment of probabilities for those outcomes (e.g., an increase in weight of a patient may, at a 25% probability, signal an impending de-compensation event and/or indicate that other tests are needed). The learning module 506 performs probabilistic calculations and selects a given response based on less than a 100% probability. Further, as the learning module 506 “learns” for previous determinations (e.g., through a neural network configuration), the learning module 506 becomes more proficient at assigning probabilities for a given data pattern, thereby being able to more confidently select a given response. As the amount of data that has been analyzed by the learning module 506 grows, the learning module 506 becomes more and more accurate at assigning probabilities based on data patterns. A bifurcated analysis may be performed for diseases exhibiting similar symptoms. As progressive quantities of data are collected and the understanding of a given disease state advances, disease analysis is refined where a former singular classification may split into two or more sub-classes.

In addition, patient-specific clinical information can be stored and tracked for hundreds of thousands of individual patients, enabling a first-level electronic clinical analysis of the patient's clinical status and an intelligent estimate of the patient's short-term clinical prognosis. The learning module 506 is capable of tracking and forecasting a patient's clinical status with increasing levels of sophistication by measuring a number of interacting co-morbidities, all of which may serve individually or collectively to degrade the patient's health. This enables learning module 506, as well as caregivers, to formulate a predictive medical response to oncoming acute events in the treatment of patients with chronic diseases such as heart failure, diabetes, pain, cancer, and asthma/COPD, as well as possibly head-off acute catastrophic conditions such as MI and stroke.

Delivery module 118 coordinates the delivery of feedback based on the analysis performed by the host 112. In response to the analysis module 116, delivery module 118 can manage the devices 102, 104, and 106, perform diagnostic data recovery, program the devices, and otherwise deliver information as needed. In some embodiments, the delivery module 118 can manage a web interface that can be accessed by patients or caregivers. The information gathered by an implanted device can be periodically transmitted to a web site that is securely accessible to the caregiver and/or patient in a timely manner. In other embodiments, a patient accesses detailed health information with diagnostic recommendations based upon analysis algorithms derived from leading health care institutions.

For example, the caregiver and/or patient can access the data and analysis performed on the data by accessing one or more general content providers. In one example, the patient's health information is accessed through a general portal such as My Yahoo provided by Yahoo! Inc. of Sunnyvale, Calif. A patient can access his or her My Yahoo homepage and receive information regarding current health and trends derived from the information gathered from the devices 102, 104, and 106, as well as other health information gathered from other sources. The patient may also access other information in addition to health information on the My Yahoo website, such as weather and stock market information. Other electronic delivery methods such as email, facsimile, etc. can also be used for alert distribution.

In an alternative embodiment, the data collected and integrated by the advanced patient system 100, as well as any analysis performed by the system 100, is delivered by delivery module 118 to a caregiver's hospital computer system for access by the caregiver. A standard or custom interface facilitates communication between the APM system 100 and a legacy hospital system used by the caregiver so that the caregiver can access all relevant information using a system familiar to the caregiver.

The APM system 100 can also be configured so that various components of the system (e.g., ITU 108, communication system 110, and/or host 112) provide reporting to various individuals (e.g., patient and/or caregiver). For example, different levels of reporting can be provided by (1) the ITU 108 and (2) the host 112. The ITU 108 may be configured to conduct rudimentary analysis of data gathered from devices 102, 104, and 106, and provide reporting should an acute situation be identified. For example, if the ITU 108 detects that a significant heart arrhythmia is imminent or currently taking place, the ITU 108 provides reporting to the patient in the form of an audible or visual alarm.

The host 112 can provide a more sophisticated reporting system. For example, the host 112 can provide exception-based reporting and alerts that categorize different reporting events based on importance. Some reporting events do not require caregiver intervention and therefore can be reported automatically. In other escalating situations, caregiver and/or emergency response personnel need to become involved. For example, based on the data collected by the APM system 100, the delivery module 118 can communicate directly with the devices 102, 104, and 106, contact a pharmacy to order a specific medication for the patient, and/or contact 911 emergency response. In an alternative embodiment, the delivery module 118 and/or the patient may also establish a voice communication link between the patient and a caregiver, if warranted.

In addition to forms of reporting including visual and/or audible information, the APM system 100 can also communicate with and reconfigure one or more of the devices 102, 104, and 106. For example, if device 102 is part of a cardiac rhythm management system, the host 112 can communicate with the device 102 and reconfigure the therapy provided by the cardiac rhythm management system based on the data collected from one or more of the devices 102, 104, and 106. In another embodiment, the delivery module 118 can provide to the ITU 108 recorded data, an ideal range for the data, a conclusion based on the recorded data, and a recommended course of action. This information can be displayed on the ITU 108 for the patient to review or made available on the peripheral device 109 for the patient and/or clinician to review.

V. Example APM System with Pharmaceutical Emphasis

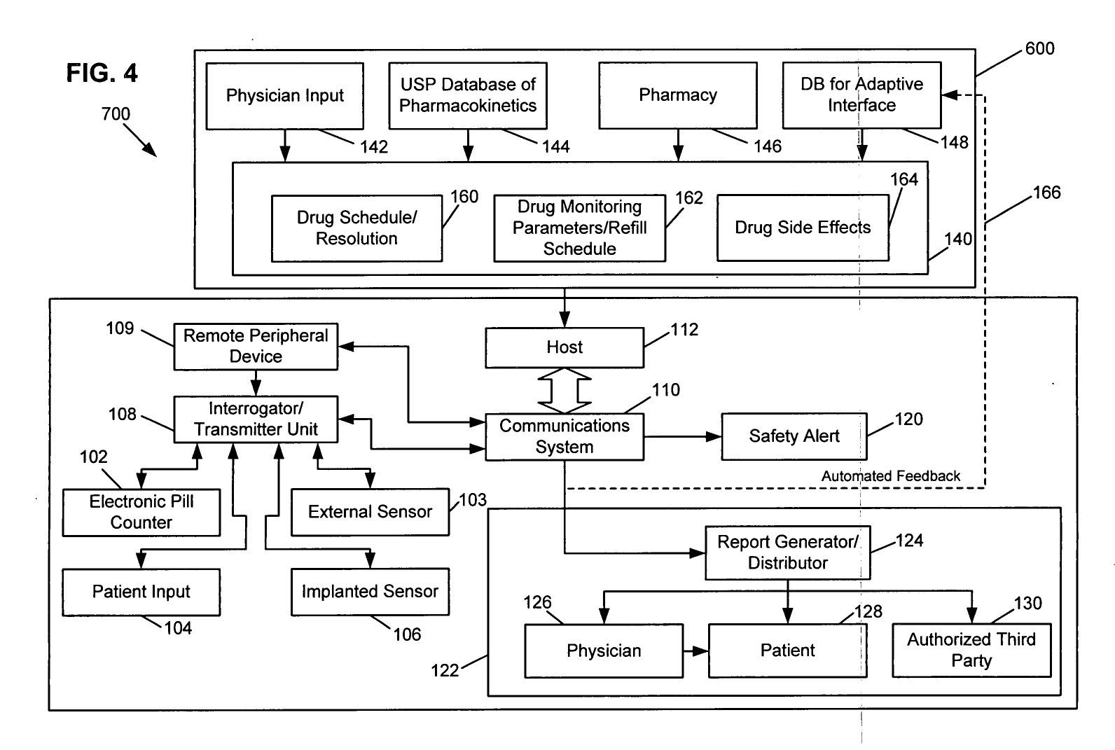

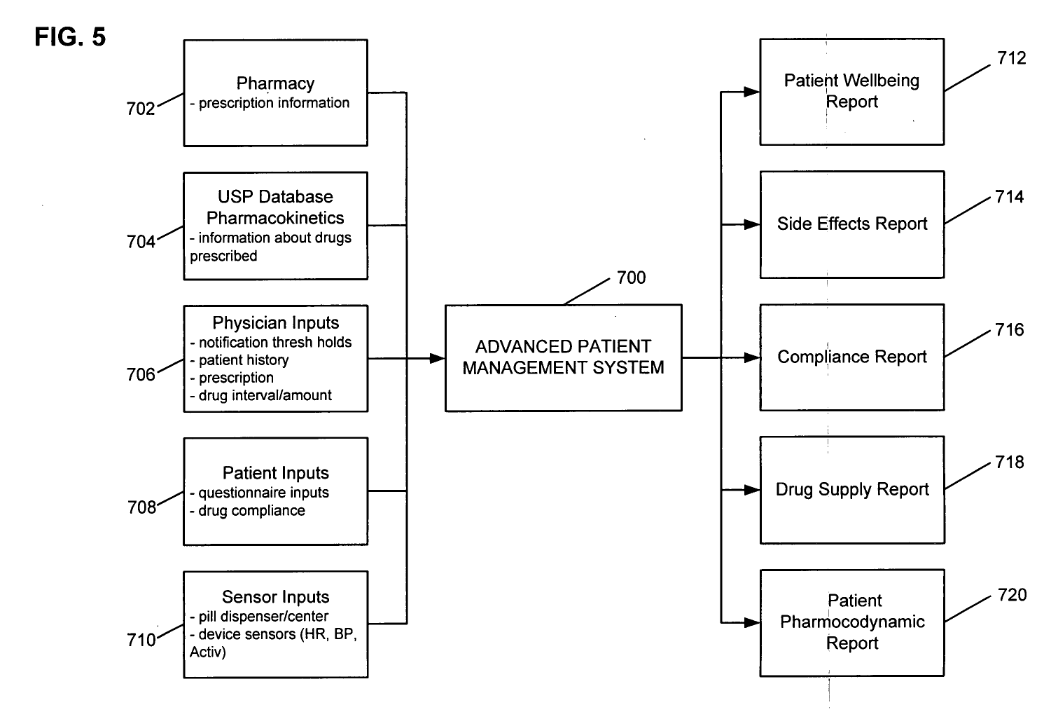

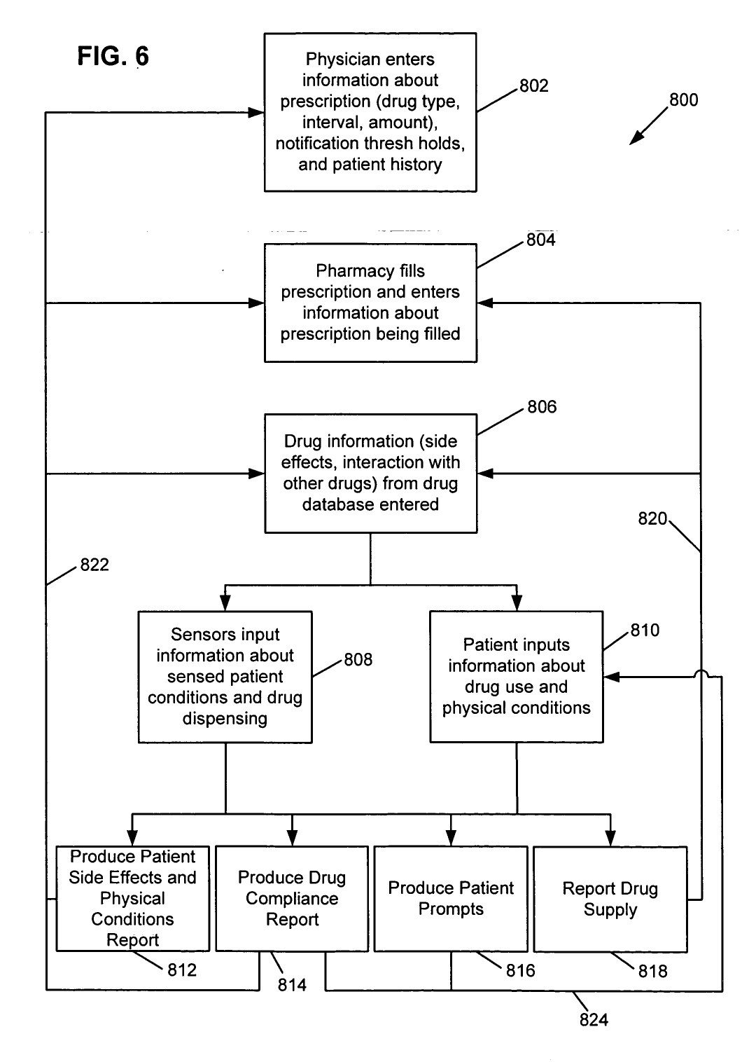

Another example advanced patient management system 700 is shown and described with reference to FIGS. 4 and 5 and the method illustrated in FIG. 6. APM system 700 generally includes the following components: devices 102, 104, 106, and 108, an interrogator/transceiver unit 108, a communication system 110, at least one remote peripheral device 109, and a host 112. APM system 700 also includes a safety alert 120, a report device 122 that includes a report generator/distributor 124 and reports to a physician 126, a patient 128, and an authorized third party 130. An external database 600 of APM system 700 includes a physician input 142, a USP (United States Pharmacopeia) database of pharmacokinetics 144, a pharmacy 146, and a database for adaptive interface 148 that provide drug parameters 140 in the form of, for example, a drug schedule/resolution 160, drug monitoring parameters/refill schedule 162 and drug side effects 164. An automated feedback 166 of APM system 700 may be used to communicate information via the communications system 110 back to the interface 148. Other feedback loops (for example, see the method of FIG. 6) may be used to communicate real-time or periodic patient information back to various databases and other features associated with APM system 700.

Each component of the APM system 700 can communicate using the communication system 110, or may be configured to communicate directly with one another. As shown in FIGS. 4 and 5, the features of APM system 700 may be used to collect certain drug and patient information and provide reports to various parties related to the patient's wellbeing, compliance with a drug regimen, side effects of the drug regimen, physical indicators of the drug efficacy, and information about the drug supply and other relevant information related to the patient.

APM system 700 may be useful in the following scenario. Following diagnosis of a disease, the physician of a patient prescribes a drug or a set of drugs to treat the disease. When a major pharmaceutical network fills the prescription, the specific drug parameters 140 (e.g., schedule of drug administration, resolution of data, pharmacokinetics, side effects, expected results, compatibility with other drugs, etc.) are uploaded to the host 112 either directly or via the communication system 110 from the pharmaceutical network 146, the physician 142, and the pharmaceutical database 144. The APM system 700 then provides patient display updates and prompts based on the merged inputs from the external database 600 via the interrogator/transmitter unit 108 and the devices 102, 103, 104, 106 and 109.

The electronic pill counter 102 may be used to dispense drugs/pills directly to the patient in their home based on the prescription information. The APM system 700 records the patient prompts and dispensed drugs, and generates various reports via the reporting device 122 based on the inputs from the patient via the devices 102, 103, 104, 106 and 109, and inputs from the external database 600. The generated reports may be sent to, for example, the physician 126, back to the patient 128, or to an authorized third party 130. The reports and other information gathered by the devices 102, 103, 104, 106 and 109 as well as information initially provided by database 600 may be communicated back to the database 600 or to the host 112 to perform updates to the databases and to perform analysis and statistics of the information for the patient and the population. In some embodiments, the reports may be generated or initiated by the host and the reporting device 122 may be used only to distribute the reports via the communication system 110. The available information and reports may also be used to update the patient's health history kept by the physician, update the pharmaceutical database, update the pharmaceutical network, or create trends for future drug treatments, therapy and other forms of patient care, for example, so that the patient is not prescribed a drug, combination of drugs, or particular drug dosage again in the future due to certain undesired side effects.

The database for adaptive interface 148 may use some of the available information in real-time or periodic intervals to automatically update and/or change the patient therapy or drug treatment regimen. Information and reports provided to the physician may be used by professionals at a clinic or by the physician directly to override the current drug prescription by changing dosages, time intervals, or to change drug or drugs being taken by the patient. For example, if a patient develops a severe side effect or becomes refractory to a certain drug, the treatment should be changed. In one specific example, a heart failure patient could develop renal dysfunction (assessed from their blood chemistry parameters) and become refractory to diuretics. The drug treatment should be changed immediately in this situation to avoid other severe health problems for the patient.

APM system 700 may be particularly useful for monitoring a patient during application of a new or revised drug regimen because system 700 can identify certain problems and complications relatively quickly and can likewise monitor sensor feedback and patient performance in a reliable, time-sensitive manner for an indication that the drug regimen is working properly. APM system 700 is also configured to perform certain functions automatically while providing for relative ease in modifying system parameters, for example, a drug prescription, patient condition thresholds for alarm indicators, etc.

A method 800 of using an APM system according to principles of the present invention to monitor and implement a drug regimen and provide reports of patient conditions and drug regimen compliance is illustrated with reference to FIG. 6. The method includes a step 802 of the physician entering information about the prescription (e.g., drug type, interval, and amount), notification thresholds, and the patient health history into the APM system. Another step 804 includes the pharmacy filling the prescription and entering information about the prescription being filled into the APM system. A further step 806 of entering drug information (e.g., side effects and interaction with other drugs) from a drug database into the APM system. At the patient side of the method, a step 808 includes the sensors inputting information about sensed patient conditions and drug dispensing into the APM system, and the patient inputting information about drug use and physical conditions into the APM system.

The method 800 also includes producing a number of reports in response to the information gathered into the APM system in steps 802, 804, 806, 808 and 810. A step 812 includes producing a patient side effects and physical conditions report, a step 814 includes producing a drug compliance report, a step 816 includes producing patient prompts, and a step 818 includes reporting drug supply information. The reports 812, 814, 816 and 818 and other relevant patient and drug information can be fed back to any of the other steps in the method as shown by feedback loops 820, 822, 824.

VI. Conclusion

One or more headings have been provided above to assist in describing the various embodiments disclosed herein. The use of headings, and the resulting division of the description by the headings, should not be construed as limiting in any way. The subject matter described under one heading can be combined with subject matter described under one or more of the other headings without limitation and as desired.

The systems and methods of the present disclosure can be implemented using a system as shown in the various figures disclosed herein, including various devices and/or programmers, including implantable or external devices. Accordingly, the methods of the present disclosure can be implemented: (1) as a sequence of computer implemented steps running on the system; and (2) as interconnected modules within the system. The implementation is a matter of choice dependent on the performance requirements of the system implementing the method of the present disclosure and the components selected by or utilized by the users of the method. Accordingly, the logical operations making up the embodiments of the method of the present disclosure described herein can be referred to variously as operations, steps, or modules. It will be recognized by one of ordinary skill in the art that the operations, steps, and modules may be implemented in software, in firmware, in special purpose digital logic, analog circuits, and any combination thereof without deviating from the spirit and scope of the present invention as recited within the claims attached hereto.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A pharmaceutical monitoring system comprising a communication system, a host, and an interrogator/transmitter unit, the communication system being configured to upload patient drug parameters from a pharmaceutical information source to the host, and the interrogator/transmitter unit being configured to download the patient drug parameters from the host via the communication system, provide patient prompts based on the downloaded patient drug parameters, receive patient inputs in response to the patient prompts, and upload information to the host via the communication system that is based on the patient inputs, patient prompts, and patient drug parameters.

2. The system of claim 1, further comprising a pill/drug dispenser, and the interrogator/transmitter unit is further configured to communicate with the pill/drug dispenser.

3. The system of claim 1, wherein the network is configured to generate a compliance report based on the uploaded information from the interactive device.

4. The system of claim 1, further comprising a sensor configured to sense at least one physical condition of the patient and communicate the sensed condition to the interrogator/transmitter unit or to the communication system.

5. The system of claim 1, wherein the interrogator/transmitter unit is configured to produce a notification signal in response to a predetermined condition.

6. The system of claim 5, wherein the predetermined condition is a physical condition having a measurable value that is outside a threshold value.

7. The system of claim 5, wherein the predetermined condition is an irregular drug usage outside of a threshold value.

8. The system of claim 5, wherein parameters of the predetermined condition are set by a physician and uploaded to the host via the communication system.

9. The system of claim 1, wherein the patient drug parameter includes information about the drug and information about prescribed usage of the drug.

10. A method of monitoring compliance of a drug regimen using a communication system, a host, and an interrogator/transmitter unit, the method comprising the steps of:
uploading a set of patient drug parameters to the host via the network;
downloading the patient drug parameters from the host onto the interrogator/transmitter unit via the communication system;
entering patient inputs into the interrogator/transmitter unit; and
generating a compliance report based on the drug parameters and patient inputs.

11. The method of claim 10, wherein the method comprises sensing a patient physical condition with a sensor and uploading the sensed physical condition to the host via the communication system.

12. The method of claim 10, wherein the method further comprises the step of activating a pill/drug dispenser with the interrogator/transmitter unit based on the drug parameters.

13. The method of claim 10, further comprising uploading the patient inputs to the host via the communication system.

14. The method of claim 10, further comprising generating patient prompts with the interrogator/transmitter unit based on the patient drug parameters.

15. The method of claim 10, further comprising uploading physician generated patient and drug-related information to the host via the communication system.

16. The method of claim 15, wherein the physician generated patient information includes patient health history and predetermined patient threshold values.

17. The method of claim 15, wherein the drug-related information includes drug type and usage information.

18. The method of claim 10, wherein the uploading step includes uploading at least one of pharmacokinetics, a schedule of drug administration, a resolution of data, and side effects of the drug.

19. The method of claim 10, further comprising the step of updating the drug parameters based on the compliance report.

20. The method of claim 10, further comprising the step of generating an alert signal if a predetermined condition is met.

21. The method of claim 10, wherein the uploading and downloading steps include wireless communications between the network and the interactive patient device.

22. The method of claim 10, further comprising the step of delivering the generated compliance report to at least one of a physician, the patient, and an authorized third party.

23. A method of monitoring a drug related patient condition from a remote location using a communication system and an interrogator/transmitter unit, the method comprising the steps of:
downloading drug parameters from the communication system to the interrogator/transmitter unit;
entering drug related patient inputs into the interrogator/transmitter unit;
uploading the patient inputs from the interrogator/transmitter unit onto the communication system; and
accessing the patient inputs from a remote location via the communication system to determine a patient condition.

24. The method of claim 23, wherein the patient condition is efficacy of a drug, and the patient inputs represent the frequency of drug consumption.

25. The method of claim 23, wherein the patient inputs include sensed patient physical conditions.

26. The method of claim 23, further comprising generating patient prompts with the interactive device.

27. The method of claim 23, further comprising uploading physician generated patient and drug information to the network.

28. The method of claim 26, further comprising generating reports based on the patient inputs and drug parameters.
